(19) United States
(12) Patent Application Publication
(10) Pub. No.: US 2010/0232092 A1
(43) Pub. Date: Sep. 16, 2010

(54) IMAGE WRITING UNIT AND IMAGE RECORDING DEVICE USING THE SAME

(75) Inventor: Tetsuya SAKAMOTO, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/608,745

(22) Filed: Oct. 29, 2009

(30) Foreign Application Priority Data
Mar. 13, 2009 (JP) 2009-061773

(51) Int. Cl. H02B 1/00

(52) U.S. Cl. 361/600

(57) ABSTRACT

An image writing unit includes an image writing member writing images to an image holding member on a recording device body, a support mechanism including a supporting section allowing the writing member to be supported on a cover opened and closed for the device body, and a supported section on the member to be supported, the support mechanism supporting the writing member on the cover when the cover opens, and a positioning mechanism including a positioning section on the device body for positioning the writing member, and a positioned section on the member to be positioned, the positioning mechanism positioning the member for the holding member depending on a relationship between the positioning and positioned sections when the cover is closed. The supporting or supported section has a guide surface along a direction perpendicular to the open/close direction, and the other section allows the writing member to swing upon positioning the member.

### CROSS-REFERENCE TO RELATED APPLICATIONS

This application is based on and claims priority under 35 USC 119 from Japanese Patent Application No. 2009-061773 filed Mar. 13, 2009.

### BACKGROUND

1. Technical Field

The present invention relates to an image writing unit, and an image recording device using the same.

2. Related Art

### SUMMARY

An aspect of the invention is directed to an image writing unit that includes an image writing member, a support mechanism, and a positioning mechanism. The image writing member is for writing of images to an image holding member disposed on the side of a recording device body. The support mechanism includes a supporting section, and a supported section. The supporting section is capable of supporting the image writing member on the side of an cover that is open and closed with respect to the recording device body, and the supported section is provided to the image writing member to be supported by the supporting section. When the cover is left open, the support mechanism supports the image writing member on the side of the cover. The positioning mechanism includes a positioning section, and a positioned section. The positioning section is provided on the side of the recording device body for positioning of the image writing member, and the positioned section is provided on the side of the image writing member to be positioned by the positioning section. The positioning mechanism positions the image writing member with respect to the image holding member on the side of the recording device body depending on the positional relationship between the positioning section and the positioned section when the cover is closed. In such an image writing unit, either the supporting section or the supported section in the support mechanism is provided with a guide surface extending along the direction perpendicular to the open/close direction of the cover, and the other section allows the image writing member to swingably move in response to the positioning of the image writing member by the positioning mechanism.

### BRIEF DESCRIPTION OF THE DRAWINGS

Exemplary embodiments of the present invention will be described in detail based on the following figures, wherein:

FIGS. 1A and 1B each show the overview outline of exemplary embodiments for an image recording device adopting the invention, specifically FIG. 1A is a diagram showing the state of the image writing unit when an cover is left open, and FIG. 1B is a diagram showing the state of the image writing unit when the cover is closed;

FIG. 2A is a diagram showing that an image writing member is in the state of position held in the image writing unit of FIGS. 1A and 1B;

FIG. 2B is a diagram showing that the image writing member is in the state of position not held therein;

FIG. 3A is a diagram showing an exemplary image writing unit for a comparative example;

FIG. 3B is an arrow view of the image writing unit of FIG. 3A viewed from an arrow B therein;

FIG. 3C is a diagram illustrating the positional relationship between a support protrusion and a positioning protrusion in the image writing unit of FIG. 3A for a comparative example;

FIG. 4 is a diagram showing the entire configuration of an image recording device of a first exemplary embodiment;

FIG. 5 is a diagram showing the entire configuration of an image writing unit for use in the image recording device of the first exemplary embodiment;

FIG. 6 is a perspective view of the main components in the image writing unit of FIG. 5, viewed from the front side;

FIG. 7 is an arrow view of the image writing unit of FIG. 6, viewed from the direction of an arrow VII therein;

FIG. 8 is an arrow view of the image writing unit of FIG. 7, viewed from the direction of an arrow VIII therein;

FIG. 9 is a diagram illustrating a first state of the image writing unit of the first exemplary embodiment during an operation of closing a cover;

FIG. 10 is a diagram illustrating a second state of the image writing unit of the first exemplary embodiment during the operation of closing the cover;

FIG. 11 is a diagram illustrating a first state of a position change mechanism specifically during the operation in the image writing unit of the first exemplary embodiment for closing the cover;

FIG. 12 is a diagram illustrating a second state of the position change mechanism of FIG. 11;

FIG. 13 is a diagram illustrating a third state of the position change mechanism of FIG. 11;

FIG. 14 is a diagram illustrating a third state of the image writing unit of the first exemplary embodiment during the operation of closing the cover;

FIG. 15 is a diagram illustrating a fourth state of the image writing unit of the first exemplary embodiment during the operation of closing the cover;

FIG. 16 is a diagram illustrating a fifth state of the image writing unit of the first exemplary embodiment during the operation of closing the cover;

FIG. 17 is a diagram illustrating a first state of the image writing unit of the first exemplary embodiment during an operation of opening the cover;

FIG. 18 is a diagram illustrating a second state of the image writing unit of the first exemplary embodiment during the operation of opening the cover;

FIG. 19 is a diagram illustrating a third state of the image writing unit of the first exemplary embodiment during the operation of opening the cover;

FIG. 20A is a diagram showing a modified example of a support mechanism of the first exemplary embodiment;

FIG. 20B is a diagram showing a modified example of a positioning mechanism of the first exemplary embodiment;

FIG. 21 is a diagram showing an exemplary entire configuration of an image writing unit of a second exemplary embodiment;

FIG. 22 is a diagram showing an exemplary configuration of a recording head in the image writing unit of the second exemplary embodiment;

FIG. 23 is a diagram showing an exemplary configuration of the image writing unit of the second exemplary embodiment from which the recording head is removed;

FIG. 24 is a diagram illustrating a first state of the image writing unit of the second exemplary embodiment during the operation of closing the cover;

FIG. 25 is a diagram illustrating a second state of the image writing unit of the second exemplary embodiment during the operation of closing the cover; and

FIG. 26 is an arrow view of the image writing unit of FIG. 25, viewed from a direction of XXVI therein.

### DETAILED DESCRIPTION

### Overview Outline of Exemplary Embodiments

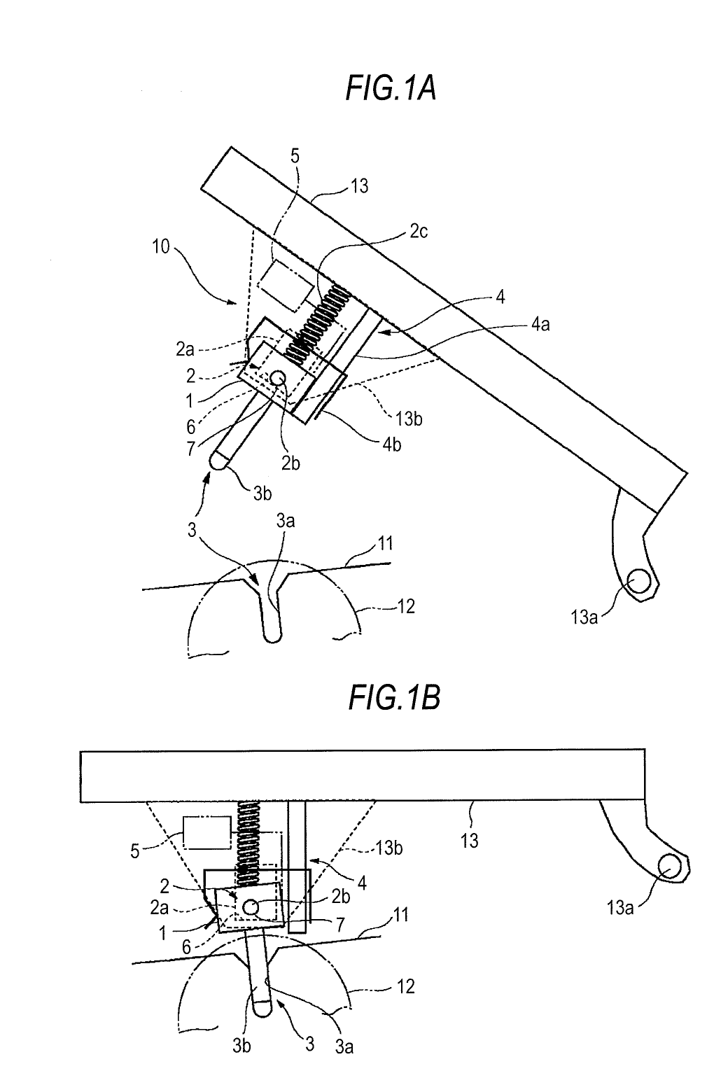

FIGS. 1A and 1B each show the overview outline of exemplary embodiments for an image recording device adopting the invention. Specifically FIG. 1A is a diagram showing the state of the image recording device when an cover is left open, and FIG. 1B is a diagram showing the state thereof when the cover is closed.

In FIGS. 1A and 1B, the image recording device is configured to include a recording device body 11, an cover 13, and an image writing unit 10. The recording device body 11 is provided with an image holding member 12. The cover 13 can open and close with respect to the recording device body 11 by swingably moving with a swing shaft 13a serving as a fulcrum, for example. The image writing unit 10 is disposed on the side of such an cover 13 for writing of images to the image holding member 12.

In the exemplary embodiments, the image writing unit 10 is basically configured to include an image writing member 1, a support mechanism 2, and a positioning mechanism 3. The image writing member 1 is for writing of images to the image holding member 12 disposed on the side of the recording device body 11. The support mechanism 2 is provided with a supporting section 2a and a supported section 2b. The supporting section 2a is capable of supporting the image writing member 1 on the side of the cover 13 that is open and closed with respect to the recording device body 11, and the supported section 2b is provided to the image writing member 1 to be supported by the supporting section 2a. When the cover 13 is left open, the support mechanism 2 supports the image writing member 1 on the side of the cover 13. The positioning mechanism 3 includes a positioning section 3a, and a positioned section 3b. The positioning section 3a is provided on the side of the recording device body 11 for positioning of the image writing member 1, and the positioned section 3b is provided on the side of the image writing member 1 to be positioned by the positioning section 3a. The positioning mechanism 3 positions the image writing member 1 with respect to the image holding member 12 on the side of the recording device body 11 depending on the positional relationship between the positioning section 3a and the positioned section 3b when the cover 13 is closed. In such an image writing unit, either the supporting section 2a or the supported section 2b in the support mechanism 2 is provided with a guide surface 6 extending along the direction perpendicular to the open/close direction of the cover 13, and the other section is provided with a protrusion 7 allowing the image writing member 1 to freely move relative to the guide surface 6 and to swingably move in response to the positioning of the image writing member 1 by the positioning mechanism 3.

With such technical means, the image writing member 1 is typically exemplified by an electrophotographic LED head, but this is surely not restrictive, and an inkjet printing head is also applicable.

The image holding member 12 herein means a photosensitive element in the configuration that the image writing member is an LED head, for example. When the image writing member is an inkjet printing head, the image holding member 12 is a recording medium for holding any recorded image. Herein, the recording medium is a paper sheet for direct retention, or is an intermediate medium for indirect retention.

The support mechanism 2 serves well as long as it includes the supporting section 2a on the side of the cover 13, and the supported section 2b on the side of the image writing member 1. The state of support achieved by the support mechanism 2 is broad in sense, i.e., when the image writing member 1 is free to move relatively along the guide surface 6, and move swingably via the protrusion 7. The guide surface 6 extends along the direction perpendicular to the open/close direction of the cover 13.

The positioning mechanism 3 is broadly applicable as long as it forms a positional relationship between the positioning section 3a on the side of the recording device body 11 and the positioned section 3b on the side of the image writing member 1 for positioning of the image writing member 1 with respect to the image holding member 12. Herein, the positioning section 3a can be a hole and groove, or a protrusion, and the positioned section 3b can be a protrusion or a hole and groove.

From the viewpoint of reducing the operation force of resetting the positioning by the positioning mechanism 3, the protrusion 7 configuring the support mechanism 2 has, preferably, outer dimensions along the guide surface 6 equal to or smaller than dimensions of a positioning width of the positioning section 3a or the positioned section 3b in the positioning mechanism 3 along the guide surface 6, and the protrusion 7 comes in contact with at least a part of the guide surface 6 of the dimensions within the positioning width.

With such a configuration, as to the positional relationship when the protrusion 7 comes in contact with the guide surface 6, the protrusion 7 does not necessarily entirely come in contact with the guide surface 6 fitting to the dimensions of the positioning width of the positioning section 3a or the positioned section 3b, and the protrusion 7 may be partially in contact with the guide surface 6.

When the protrusion 7 and the guide surface 6 are set to be in such a positional relationship, for resetting the positioning by the positioning mechanism 3, if the cover 13 is to be left open to move the positioned section 3b away from the positioning section 3a, in response to when the cover 13 is open as such, the image writing member 1 is lifted up via the protrusion 7 serving as a support point of the support mechanism 2 so that any force needed to move the positioned section 3b away from the positioning section 3a acts within the dimensions of the positioning width. In this state, because the protrusion 7 is being in contact with the guide surface 6 fitting to the dimensions of the positioning width, the positioned section 3b or the positioning section 3a is difficult to be acted upon by the force different in direction from the force needed to move the positioned section 3b away from the positioning section 3a. This is thus considered preferable because there is no possibility of tilting the positioned section 3b or the positioning section 3a when it is moved away from the other.

Another exemplary configuration for the support mechanism 2 includes a pressing member 2c from the viewpoint of stably supporting the image writing member 1. The pressing member 2c serves to push the supported section 2b on the side of the image writing member 1 toward the supporting section 2a on the side of the cover 13.

In the typical configuration of the support mechanism 2, the supporting section 2a is a support hole formed to each side wall of the cover 13, and has a hole edge portion at least formed with the guide surface 6. The supported section 2b is a support portion protruding from each of the side portions of the image writing member 1 toward the support hole, and contacting with the support hole along the guide surface 6 via the protrusion 7.

Such a support portion being the supported section 2b typically includes a protrusion portion, and the protrusion 7. The protrusion portion protrudes from each of the side portions of the image writing member 1 toward the support hole, and the protrusion 7 is formed to a part of each of the protrusion portions to contact with the support hole along the guide surface 6 to be able to freely move relatively thereto. With the protrusions 7 each serving as a fulcrum, the image writing member 1 is allowed to swingably move with respect to the cover 13. However, such a configuration is surely not the only option, and the support portion may be configured only by the protrusion serving as a fulcrum for a swingable movement. Note here that, for configuring the support hole together with the support portion, the support portion including the protrusion portion and the protrusion 7 is considered preferable in the respect that the protrusion portion using the protrusion 7 as a fulcrum for the swingable movement restricts the area range for the relative movement and that for the swingable movement.

Herein, the support mechanism 2 is surely not restrictive to such a combination of the support hole and the support portion, and the combination may be accordingly selected as long as they can implement the relative movement and the swingable movement, e.g., the supporting section 2a may be a support rod, and the supported section 2b may be a protrusion. The protrusion herein may have the cross section in the shape of a square bracket, and may be supported by the support rod, for example.

The positioning mechanism 3 is typically configured to include a positioning hole, and a positioning protrusion. The positioning hole serves as the positioning section 3a formed on the side of the recording device body 11, and the positioning protrusion serves as the positioned section 3b formed on the side of the image writing member 1 for insertion into the positioning hole. For positioning of the image writing member 1 during the operation of closing the cover 13, the positioning protrusion is disposed to make a tip end portion thereof come in contact with the bottom portion of the positioning hole, and a distance between the image holding member 12 and the image writing member 1 is set to a predetermined value.

From the viewpoint of implementing the positioning operation by the positioning mechanism 3 more smoothly, it is possible to further include a position holding mechanism 4. With the position holding mechanism 4, when the positioned section 3b of the image writing member 1 is not in contact with the positioning section 3a of the recording device body 11, during the operation of closing the cover 13, the image writing member 1 is held in position at a restraint position to be restrained by the cover 13 to form the positional relationship in which the positioned section 3b is ready for positioning by the positioning section 3a, and releasing the image writing member 1 from being in the position at the restraint position with respect to the cover 13 while the positioned section 3b is contacting with the positioning section 3a to be in a position ready for positioning.

Such a position holding mechanism 4 is surely not restrictive, and may be accordingly selected as long as it can serve well, i.e., before the positioned section 3b contacts with the positioning section 3a in the positioning mechanism 3, keeps the positioned section 3b at a restraint position in the same position for guiding it to the positioning section 3a, and while the positioned section 3b is contacting with the positioning section 3a to be in a position ready for positioning, releases the positioned section 3b from being at the restraint position to enable the positioning operation by the positioning mechanism 3.

The position holding mechanism 4 is typically configured to include a restriction wall 4a by which the image writing member 1 is restricted to take a predetermined restraint position, i.e., position when being at the restraint position, and a pressing member 4b for pressing the image writing member 1 to the restriction wall 4a.

In the configuration of the support mechanism 2 including a support hole being the supporting section 2a and a support portion being the supported section 2b, the restriction wall 4a may be an edge portion of each of the support holes serving as the supporting section 2a in the support mechanism 2, and a restricted portion may be formed to a part of each of the support portions serving as the supported section 2b in the support mechanism 2 to abut the restriction walls 4a. With such a configuration, the longer the restricted portion contacting with the restriction wall 4a, the more stably the image writing member 1 can take its restraint position.

As another configuration of the position holding mechanism 4, a restriction member may be disposed inside of the open/close door 13 to protrude therefrom, and a wall of the restriction member on the side of the image writing member 1 is used as the restriction wall 4a for restricting the position of an intermediate portion of the image writing member 1. In this configuration, the restriction member may be a reinforcing member, i.e., reinforcing rib, of the cover 13, or may be additionally provided.

From the viewpoint of smoothly releasing the image writing member 1 from being kept at the restraint position by the position holding mechanism 4, a position change mechanism 5 may be provided to, while the positioned section 3b is contacting with the positioning section 3a to be in a position ready for positioning, come in contact with the members on the side of the image writing member 1, and change the position of the image writing member 1 in a direction of being released from the restraint position. When the positioned section 3b is in the position ready for positioning, the image writing member 1 and the position change mechanism 5 are not in contact with each other.

Such a position change mechanism is typically configured to include a cam member, and an abutting member. The cam member is provided on the side of the cover 13 to be able to freely rotate, and includes a movable arm section at a part of an eccentric cam section provided also therein around a rotation shaft. The abutting member is provided on the side of the recording device body 11, and rotates the eccentric cam section of the cam member by being abutted by the movable arm section of the cam member in response to the operation of closing the cover 13. When the positioned section 3b starts to come in contact with the positioning section 3a, by the eccentric cam section of the cam member, the position of the image writing member 1 is changed in the direction of being released from the restraint position.

Movement of Image Writing Unit during Operation of Closing Cover

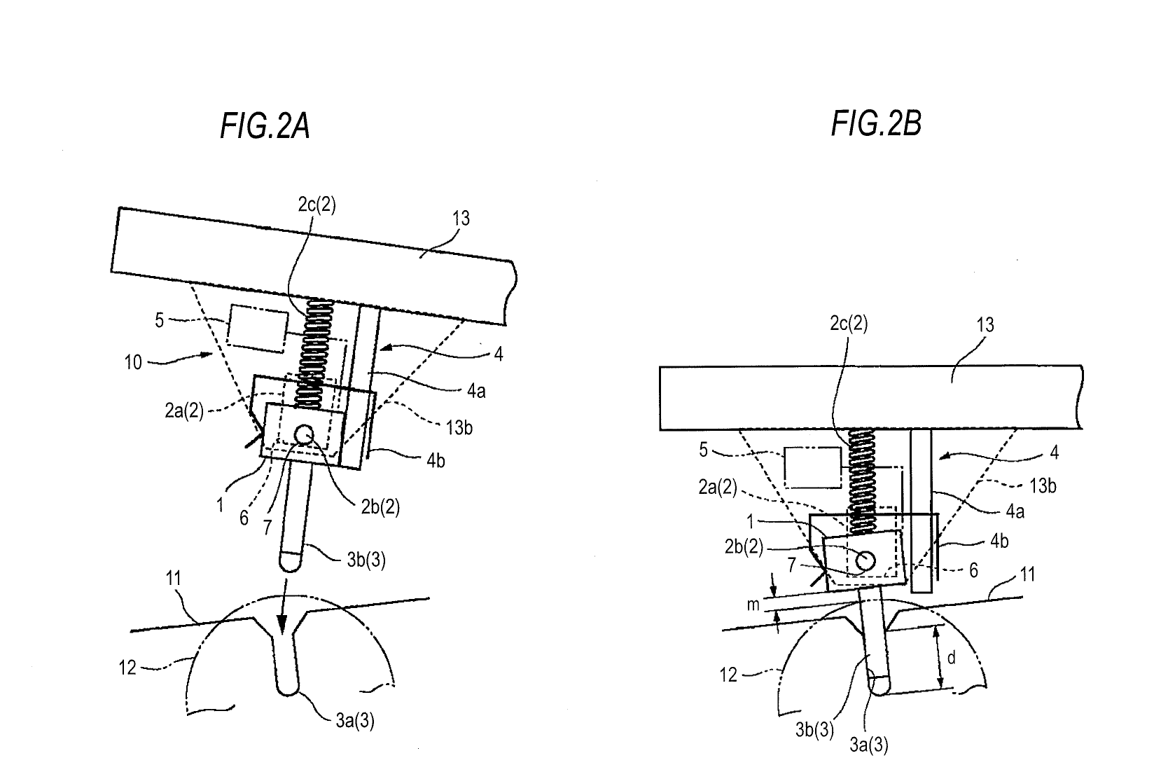

As shown in FIG. 2A, during the operation of closing the cover 13, when the positioned section 3b is not in contact with the positioning section 3a in the positioning mechanism 3, the position holding mechanism 4 holds the image writing member 1 in position at its restraint position. Accordingly, the positioned section 3b in the positioning mechanism 3 is so set as to be ready for positioning by the positioning section 3a, and when the cover 13 is closed to a further degree, the positioned section 3b in the positioning mechanism 3 is guided to the positioning section 3a.

Thereafter, when the positioned section 3b in the positioning mechanism 3 takes a position ready for positioning with respect to the positioning section 3a, the position holding mechanism 4 releases the image writing member 1 from being in the position at the restraint position so that the positioning operation by the positioning mechanism 3 can be performed smoothly. That is, the positioned section 3b in the positioning mechanism 3 remains to take a predetermined position for positioning with respect to the positioning section 3a, and has a predetermined positional relationship therewith. As shown in FIG. 2B, for example, while remaining to take a predetermined position for positioning, the positioned section 3b, i.e., positioning protrusion, is snapped into the positioning hole being the positioning section 3a to a predetermined depth d. As a result, the image writing member 1 is set to be directed in the predetermined direction for writing of images, and the image writing member 1 is so set as to have a gap m of a predetermined value from the image holding member 12, i.e., DOF: Depth of Focus.

### Movement of Image Writing Unit for Comparative Example

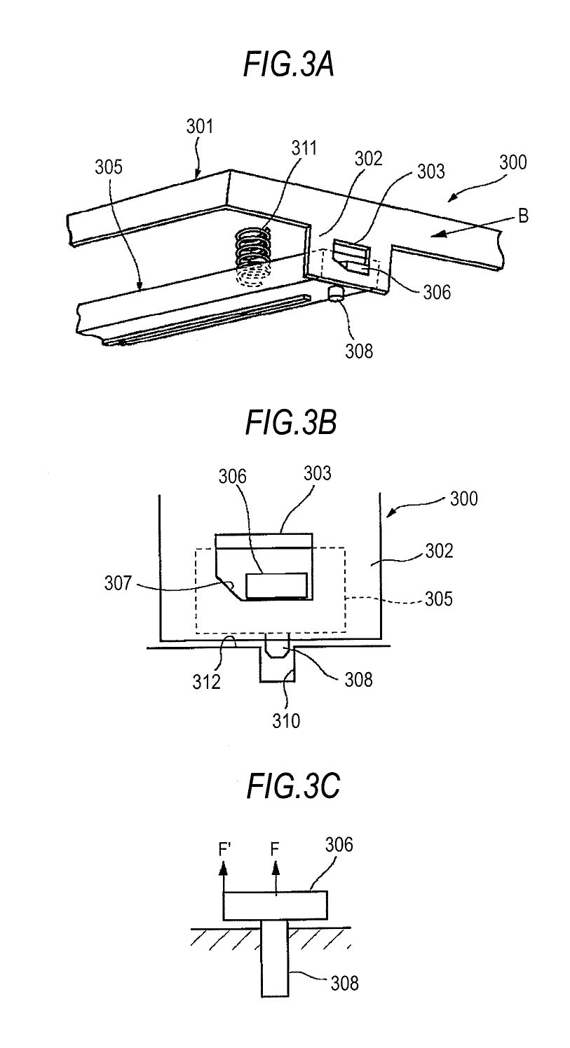

FIGS. 3A and 3B each show an image writing unit for a comparative example.

In these drawings, in an image writing unit 300, side walls 302 of an cover 301 are each formed with a support hole 303, and side end surfaces of a recording head 305 exemplified by an LED head are each formed with a support protrusion portion 306. The support protrusion portions 306 formed as such to the recording head 305 are each guided to a set position predetermined therefor along a tilted guide surface 307 formed to each of the support holes 303. When a positioning pin 308 of the recording head 305 is snapped into a positioning hole 310 (not shown) formed on the side of the device body, the support protrusion portions 306 are respectively moved away from the support holes 303. Note here that a reference numeral 311 denotes a pressing spring provided for pressing the support protrusion portions 306 of the recording head 303 toward the lower edge portions of the support holes 303.

With such a configuration for a comparative example, as shown in FIG. 3C, the support protrusion portions 306 of the recording head 305 are wider in width than the outer diameter of the positioning pin 308. Therefore, to move the positioning pin 308 from the positioning hole 310, if any deformed portion is put under a force F′ above the shaft of the positioning pin 308, for example, the positioning pin 308 will be under the force acting in the direction different from that of a force F needed for moving the positioning pin 308.

In the below, exemplary embodiments of the invention are described in detail by referring to the accompanying drawings.

### First Exemplary Embodiment

### Entire Configuration of Image Recording Device

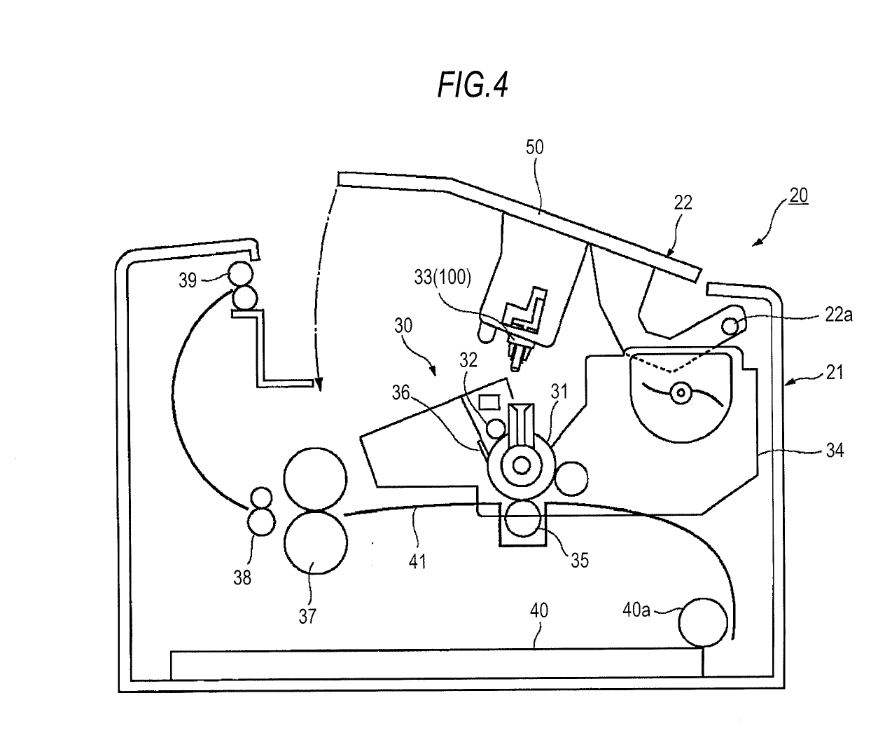

FIG. 4 is a diagram showing the entire configuration of an image recording device of a first exemplary embodiment adopting the invention.

In FIG. 4, an image recording device 20 is provided with an cover 22 that can swingably move with respect to a vertex portion of a device body 21. The device body 21 is provided therein with a process cartridge 30 including a photosensitive member 31. The process cartridge 30 is provided above a recording material supply unit 40 that can accommodate therein a recording material available for a supply. The recording material provided by such a recording material supply unit 40 is transferred to a recording material housing section 50 via the process cartridge 30 over a recording material feeding path 41. The recording material housing section 50 is configured by the cover 22 that is disposed at the top portion of the device body 21 and is in the close state.

In this exemplary embodiment, the process cartridge 30 includes, around the photosensitive member 31, a charger 32, a developing unit 34, and a cleaner 36. The charger 32 is provided for maintaining the photosensitive member 31 charged, and the developing unit 34 is provided to develop an electrostatic latent image formed on the photosensitive member 31 into a visible image using a toner. The cleaner 36 is provided to clean any toner left on the photosensitive member 31.

At a position opposing the photosensitive member 31 with the recording material feeding path 41 sandwiched therebetween, a transfer unit 35 is disposed for transferring the toner image on the photosensitive member 31 to the recording material. In the downstream to the transfer unit 35 on the recording material feeding path 41, a fixing unit 37 is provided for fixing the toner image. Note herein that a reference numeral 40a denotes a supply roll for use to supply the recording material from the recording material supply unit 40, and a reference numeral 38 denotes a feed roll disposed on the recording material feeding path 41. A reference numeral 39 denotes a discharge roll provided at a position of discharge on the recording material feeding path 41 leading to the recording material housing section 50, and is used for outputting the recording material.

In this exemplary embodiment, the cover 22 is so configured as to open and close with a swing shaft 22a serving as a fulcrum to swingably move. The side of such an cover 22 is provided with a recording head 33 being one component in an image writing unit 100.

### Image Writing Unit

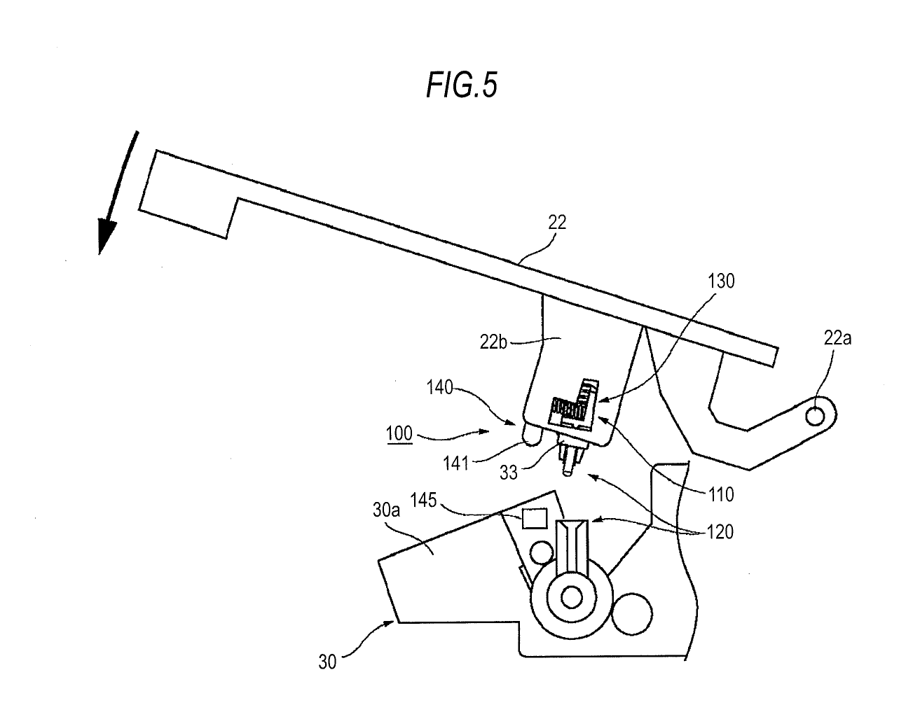

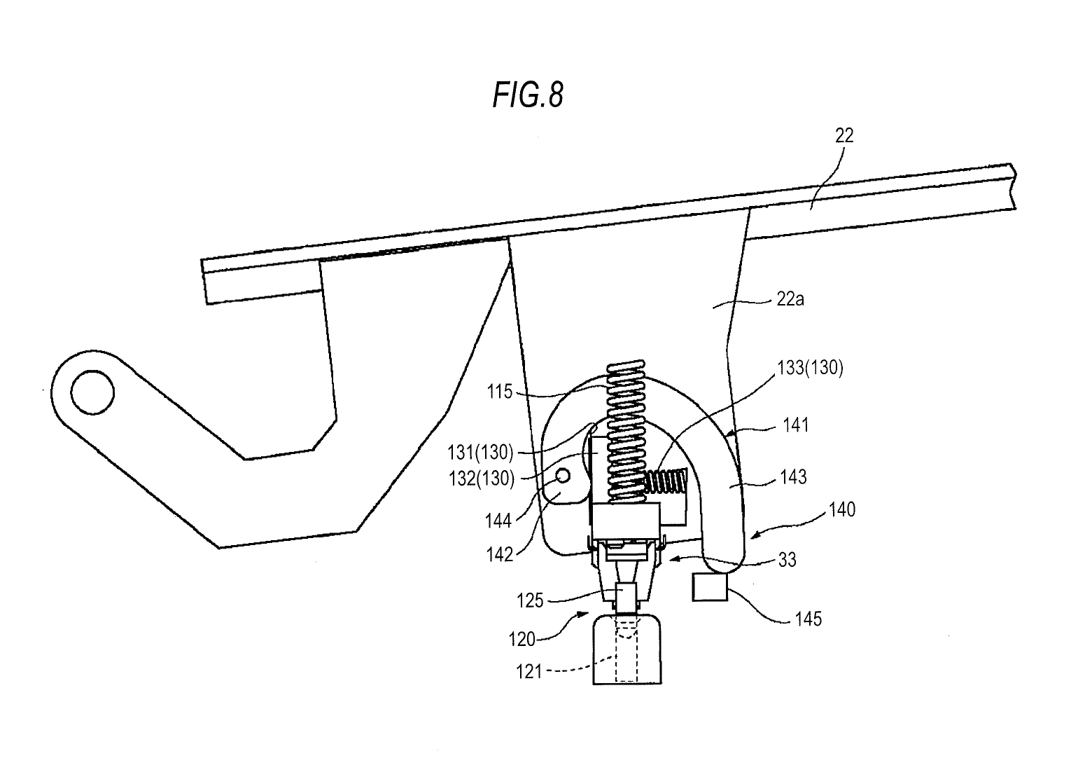

In this exemplary embodiment, as shown in FIGS. 5 to 8, the image writing unit 100 is configured to include the recording head 33, a support mechanism 110, a positioning mechanism 120, a position holding mechanism 130, and a position change mechanism 140. The recording head 33 serves to write images to the photosensitive element 31. The support mechanism 110 serves to support the recording head 33 with respect to the cover 22. The positioning mechanism 120 serves to position the recording head 33 with respect to the photosensitive element 31. The position holding mechanism 130 serves to keep the recording head 33 at its predetermined restraint position before positioning by the positioning mechanism 120. The position change mechanism 140 serves to change the position of the recording head 33 toward the direction of releasing the recording head 33 from the restraint position before the recording head 33 is made to take a position ready for positioning by the positioning mechanism 120.

### Recording Head

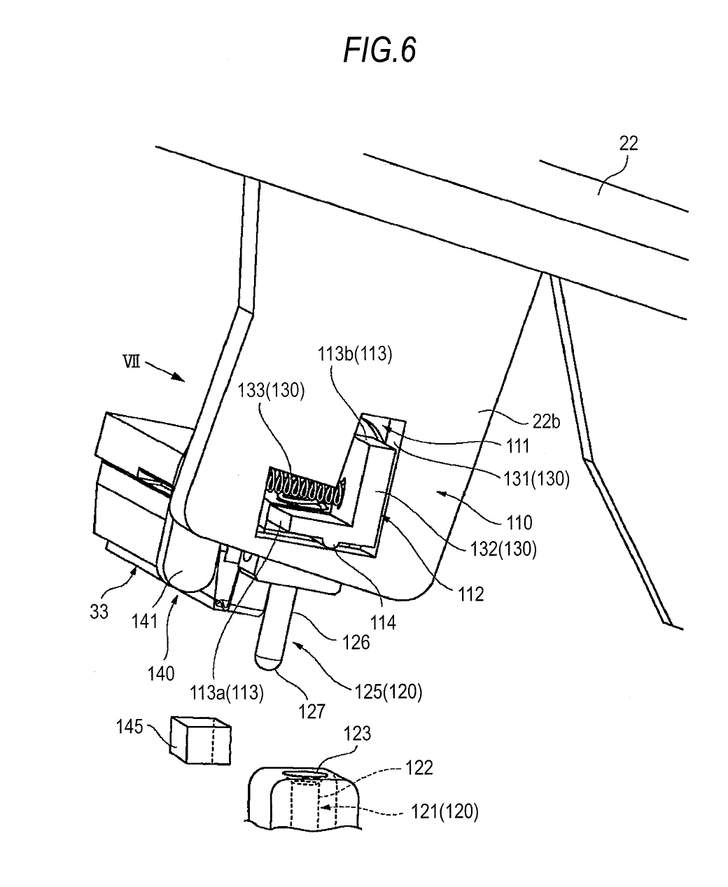

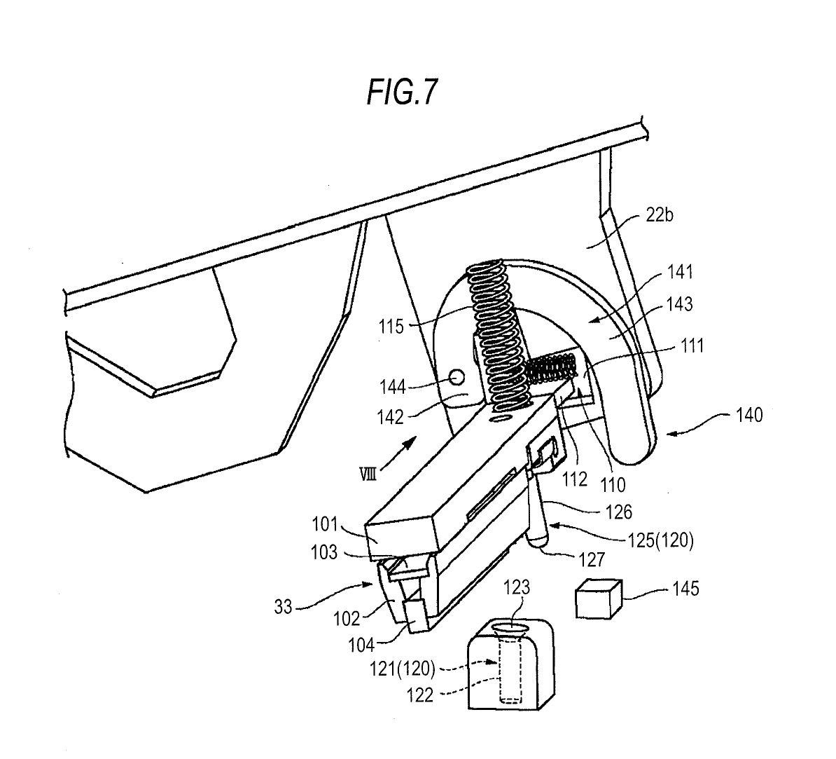

As shown in FIGS. 6 and 7, the recording head 33 includes a plate-like base member 101 extending along the axial direction of the photosensitive element 31. This base member 101 is attached with a holder member 102, which supports a substrate 103 on which LEDs are arranged with a predetermined pitch interval. In such a holder member 102, a converging lens (SELFOC lens) 104 is held between each of the LEDs on the substrate 103 and the photosensitive element 31, thereby directing a light from each of the LEDs of the substrate 103 to the photosensitive element 31 for convergence.

### Support Mechanism

The support mechanism 110 of the recording head 33 is provided with plate-like side walls 22b inside of the cover 22 in the longitudinal direction of the recording head 33. These side walls 22b are each formed with a support hole 111 shaped substantially like a letter L for use as the support section, and the base member 101 of the recording head 33 is formed with, at each end in the longitudinal direction, a guide surface of the support hole 111 extending perpendicular to the open/close direction of the cover 22, e.g., a support portion 112 to be supported by the lower edge portion of the cover 22 along the cover surface. The support portion 112 provided as such is pushed by a spring 115 by being pressed to the lower edge portion of each of the support holes 111.

In this exemplary embodiment, the support portion 112 is configured to include a protrusion portion 113, and a swing fulcrum protrusion 114. The protrusion portion 113 has the cross section in the shape of a letter L, protruding from each end of the base member 101 of the recording head 33 to the outside. The swing fulcrum protrusion 114 is substantially semi-cylindrical in shape, protruding toward the lower edge portion of each of the support holes 111 substantially at the center of a lateral-protrusion portion 113a, which is a part of the protrusion portion 113, and extends along the lower edge portion of each of the support holes 111.

### Positioning Mechanism

As shown in FIGS. 5 to 8, the positioning mechanism 120 is configured to include a positioning hole 121, and a positioning protrusion 125. The positioning hole 121 serves as a positioning section formed to a part of a cartridge body 30a of the process cartridge 30. The positioning protrusion 125 is substantially cylindrical, and at each end portion of the base member 101 of the recording head 33 in the longitudinal direction, is protruding toward the positioning hole 121, and is snapped into the positioning hole 121.

In this exemplary embodiment, the positioning hole 121 is provided with a circular hole section 122 whose internal diameter corresponds to the outer diameter of the positioning protrusion 125. An entrance portion of this circular hole section 122 is formed with a wider hole section 123, which is so formed that the internal diameter is increased by degrees toward the end of the entrance portion.

On the other hand, the positioning protrusion 125 is configured by forming a hemispherical protrusion section 127 at the tip end of a cylindrical protrusion section 126. For positioning to the positioning hole 121, the hemispherical protrusion section 127 is so disposed as to come in contact with the bottom portion of the positioning hole 121.

### Position Holding Mechanism

The position holding mechanism 130 is provided with a restriction wall 131, and a restricted portion 132. The restriction wall 131 is an edge portion in the vertical direction being perpendicular to the lower edge portions of the support holes 111 of the support mechanism 110. The restricted portion 132 is a vertical protrusion portion 113b extending vertically along the protrusion portion 113, and abutting the restriction wall 131. The vertical protrusion portion 113 is a part of the support portion 112 of the support mechanism 110. Using a pressing spring 133, the restricted portion 132 is always pressed to the restriction wall 131.

In this exemplary embodiment, the restraint position is the position of the recording head 33 when the restricted portion 132 abuts the restriction wall 131. When the recording head 33 is held at the restraint position, the positioning protrusion 125 of the positioning mechanism 120 is so set as not to come in contact with the positioning hole 121, and the line being the extension of the axis of the positioning protrusion 125 is so set as to direct the wider hole section 123 of the positioning hole 121.

### Position Change Mechanism

Also in the exemplary embodiment, the position change mechanism 140 is provided with a cam member 141, and an abutting member 145. The cam member 141 is provided to one of the side walls 22b of the cover 22 to be able to freely rotate, and includes an eccentric cam section 142 around a rotation shaft 144. The cam member 141 is also provided with a movable arm section 143 to a part of the eccentric cam section 142. The abutting member 145 is provided on the side of the cartridge body 30a, and rotates the eccentric cam section 142 of the cam member 141 by being abutted by the movable arm section 143 of the cam member 141 in response to the operation of closing the cover 22.

Herein, in the cam member 141, when the positioning protrusion 125 of the positioning mechanism 120 starts to come in contact with the positioning hole 121, the movable arm section 143 abuts the abutting member 145, and before the positioning protrusion 125 takes a position to be ready for positioning, the eccentric cam section 142 rotates and thus abuts the recording head 33 in response to the rotation of the movable arm section 143 around the rotation shaft 144, thereby moving away the recording head 33 in the direction of releasing the recording head 33 from being in the position at the restraint position.

In this exemplary embodiment, when the positioning protrusion 125 takes the position ready for positioning, the recording head 33 and the cam member 141 of the position change mechanism 140 are not in contact with each other.

### Movement of Image Writing Unit During Operation of Closing Cover

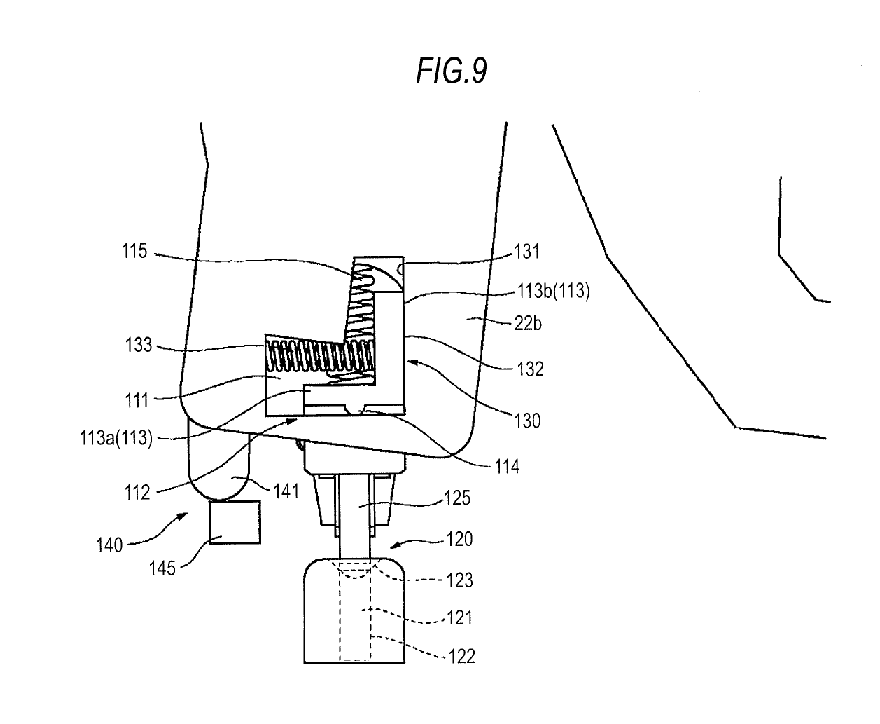

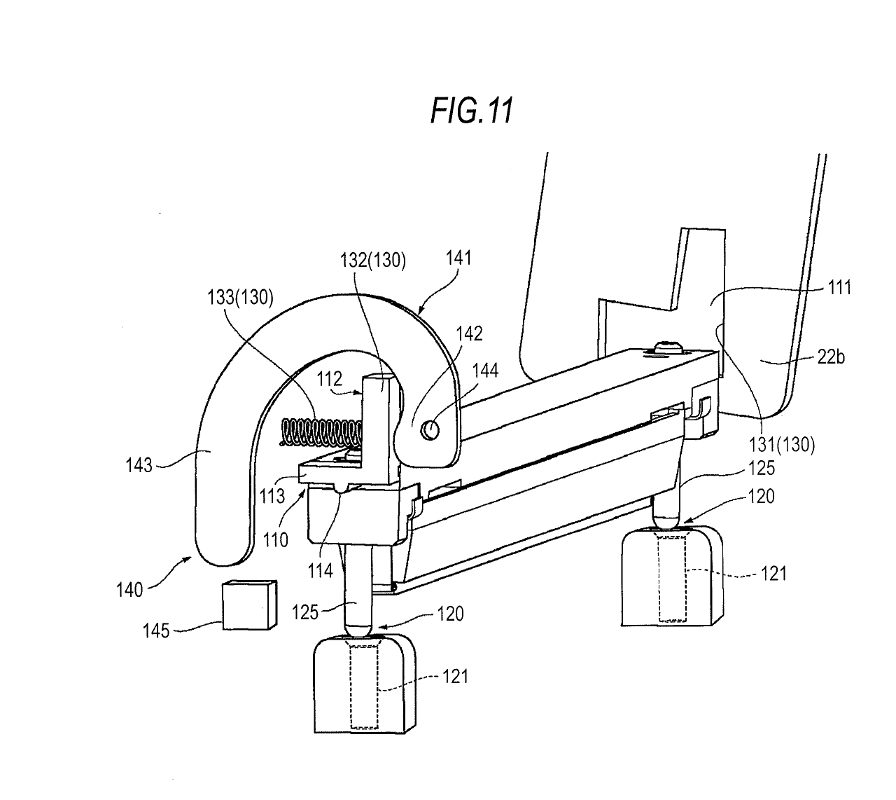

Described first is the movement of the image writing unit 100 during the operation of closing the cover 22 by referring to FIGS. 9 to 16.

In the course of closing the cover 22 being in the open position, as shown in FIG. 9, immediately before the positioning protrusion 125 of the positioning mechanism 120 is inserted into the positioning hole 121, the cam member 141 of the position change mechanism 140 abuts the abutting member 145.

As such, when the positioning protrusion 125 of the positioning mechanism 120 is in the state of no contact with the positioning hole 121, the restricted portion 132 of the position holding mechanism 130 is pressed by the pressing spring 133 to the restriction wall 131 being one side edge of the support hole 111 so that the recording head 33 is held at the restrain position defined by the restriction wall 131.

In this state, the line being the extension of the axis of the positioning protrusion 125 is located at the position opposing the wider hole section 123 of the positioning hole 121.

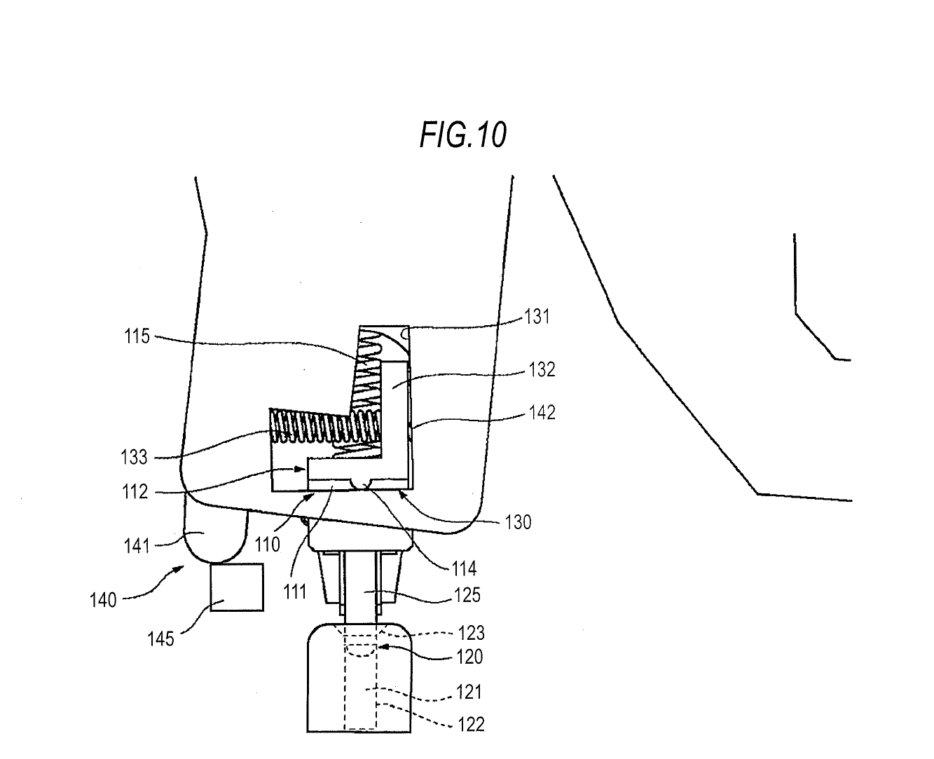

As such, when the cover 22 is closed to a further degree, as shown in FIGS. 9 and 10, the positioning protrusion 125 is directed into the circular hole section 122 for snapping thereinto through the wider hole section 123 of the positioning hole 121, thereby taking the position for positioning.

Also in this exemplary embodiment, in the course of the operation until the positioning protrusion 125 takes the position ready for positioning after being snapped into the positioning hole 121, the position change mechanism 140 is operated as below.

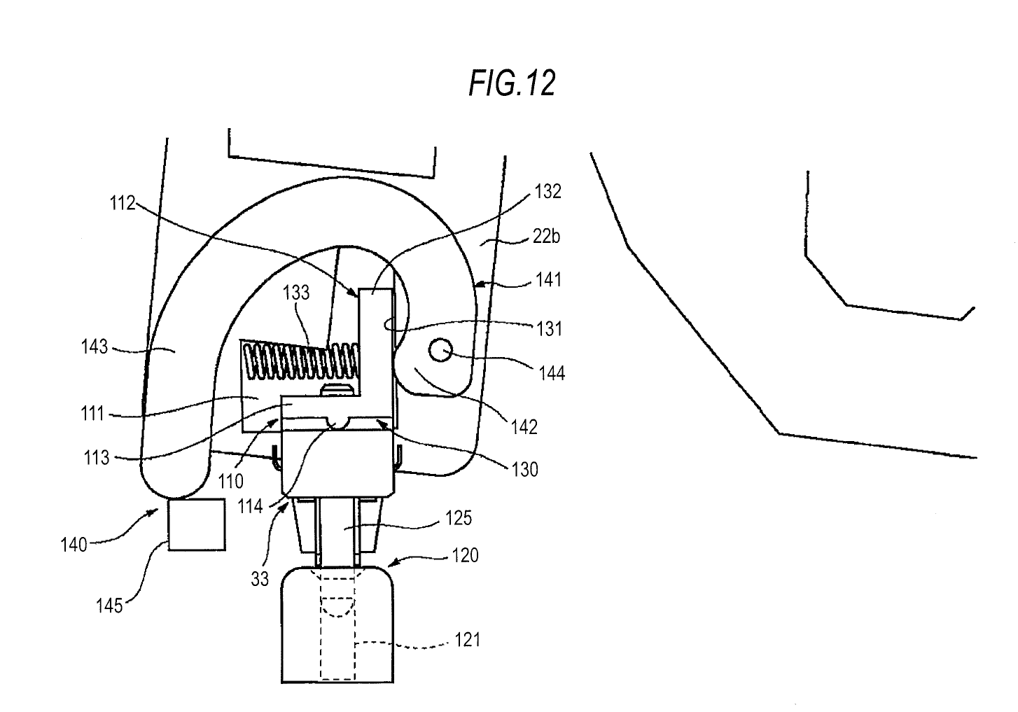

That is, as shown in FIGS. 10 to 13, in the cam member 141, in response to the operation of closing the cover 22, the movable arm section 143 abuts the abutting member 145, and the movable arm section 143 rotates upward about the rotation shaft 144. In response thereto, the eccentric cam member 142 starts operating to rotate about the rotation shaft 144. As a result, as shown in FIG. 12, the eccentric cam section 142 of the cam member 141 thus goes beyond the restriction wall 131 of the support hole 111, and enters in the support hole 111. Accordingly, the restricted portion 132 of the position restriction mechanism 130 is pressed by the eccentric cam section 142 of the cam member 141, and is released from being restrained at the restraint position. In response thereto, the position of the recording head 33 is changed from the one being restrained at the restraint position. Such a position change of the recording head 33 favorably leads to a higher degree of correspondence between the line being the extension of the axis of the positioning protrusion 125 of the positioning mechanism 120 with the center axis of the positioning hole 121 compared with the degree of correspondence before the position change of the recording head 33 as such. Therefore, the snapping between the positioning protrusion 125 of the positioning mechanism 120 and the positioning hole 121 can be completed more smoothly so that the positioning operation by the positioning mechanism 120 can be performed with a better stability.

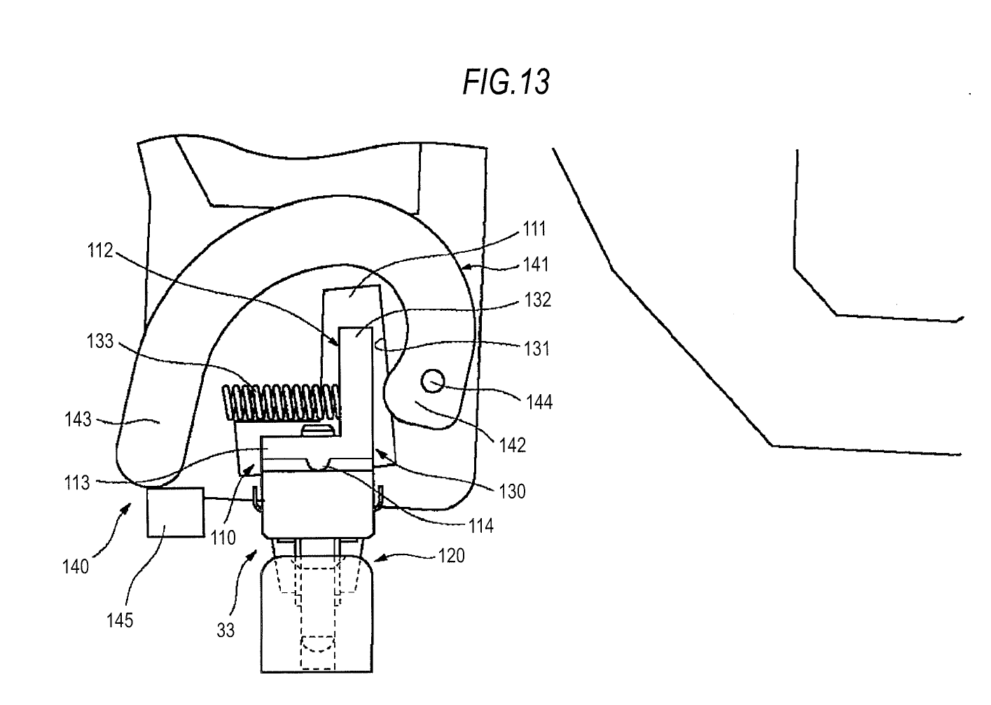

In this exemplary embodiment, before the completion of the positioning operation by the positioning mechanism 120, as shown in FIG. 13, the position change mechanism 140 makes the eccentric cam section 142 of the cam member 141 not to come in contact with the restricted portion 132. There is thus no concern about the position change mechanism 140 disturbing the operation of positioning by the positioning mechanism 120.

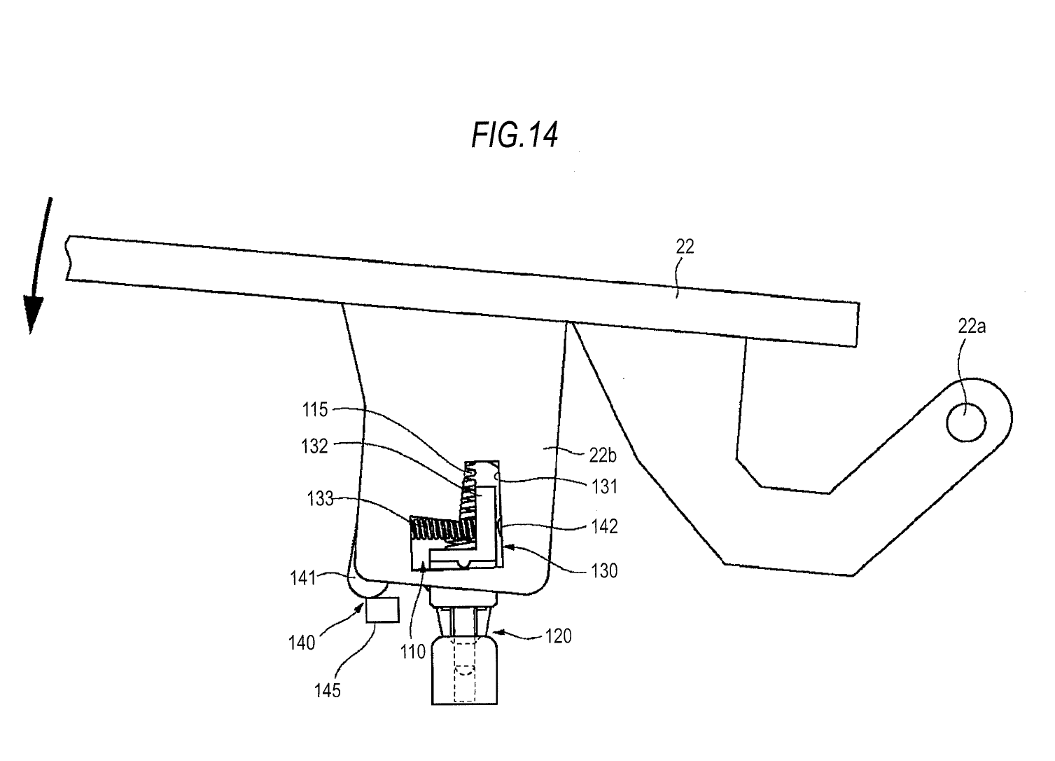

In this exemplary embodiment, in the course of the operation of closing the cover 22, as exemplarily shown in FIG. 14, when the positioning protrusion 125 in the positioning mechanism 120 is inserted into the positioning hole 121 about a half thereof, the eccentric cam member 142 of the cam member 141 and the restricted portion 132 are not in contact with each other.

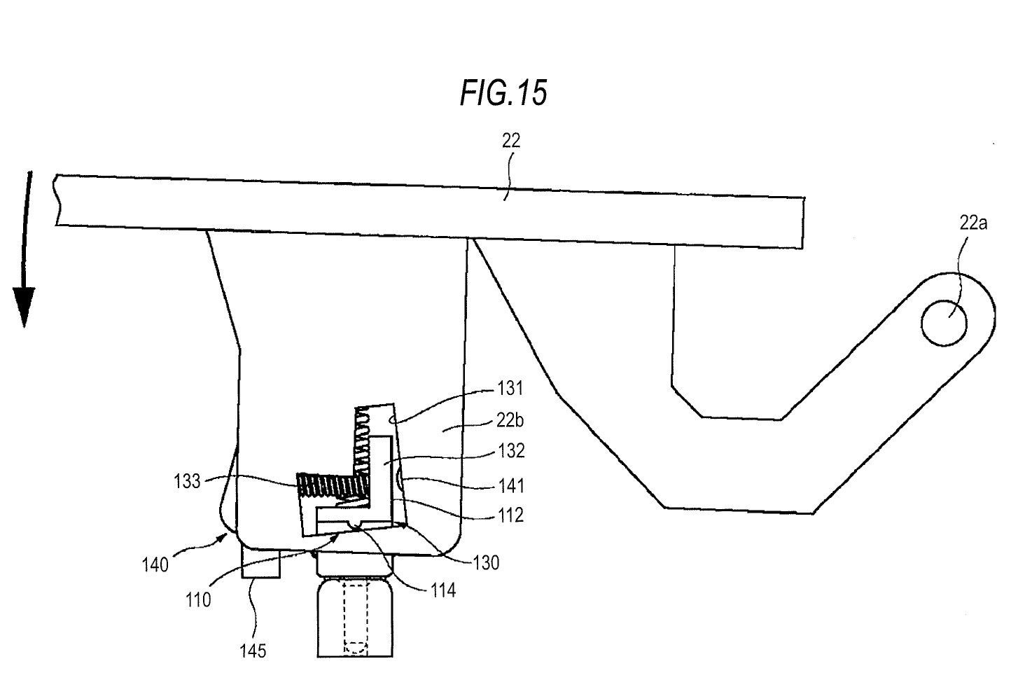

Thereafter, when the cover 22 is closed to a further degree, as shown in FIG. 15, the positioning protrusion 125 of the positioning mechanism 120 is completely inserted to reach the bottom portion of the positioning hole 121.

In this stage, however, the swing fulcrum protrusion 114 of the support portion 112 on the side of the recording head 33 remains in contact with the lower edge portion of the support hole 111, and the cover 22 remains in contact with the recording head 33.

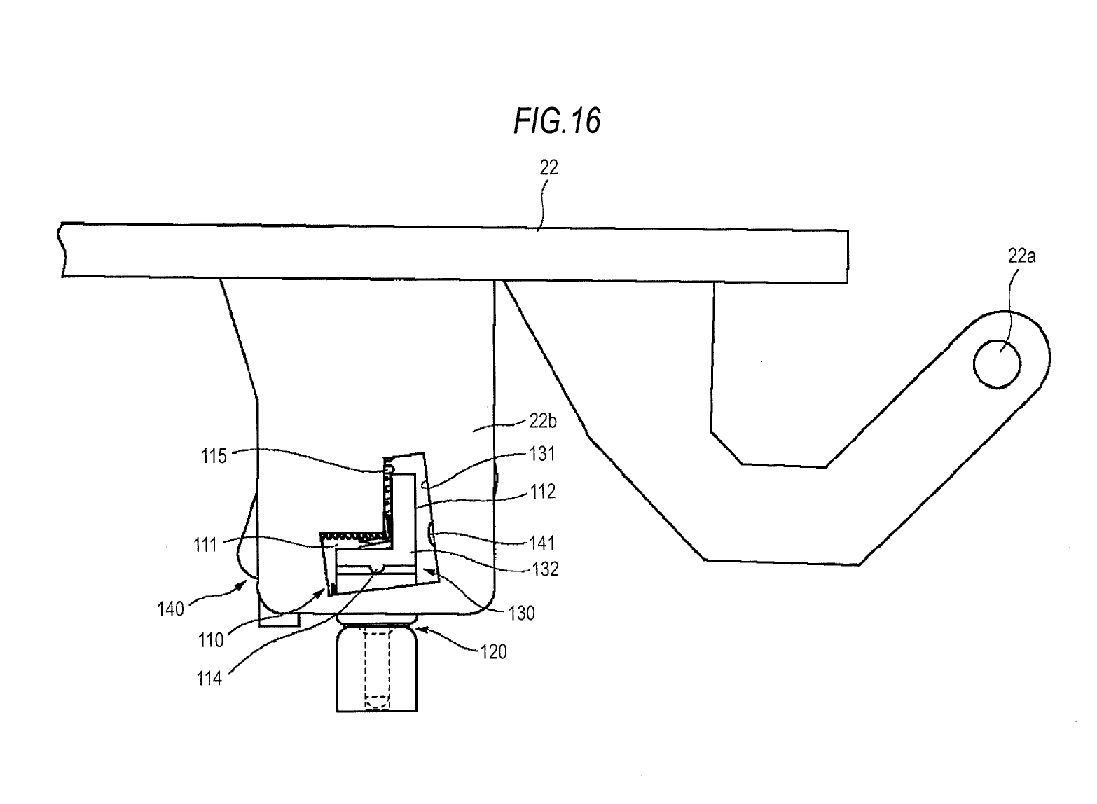

When the cover 22 is completely closed, as shown in FIG. 16, the swing fulcrum protrusion 114 of the support portion 112 of the recording head 33 is not in contact with the lower edge portion of the support hole 111 any more, and thus the contact having been established between the recording head 33 and the cover 22 is now uncoupled. Accordingly, the recording head 33 is positioned only by the positioning mechanism 120.

At this time, at where and in what position the recording head 33 is positioned is determined by the degree of snapping between the positioning protrusion 125 of the positioning mechanism 120 and the positioning hole 121. If the positioning protrusion 125 is defined by length in advance, and if the positioning hole 121 is defined by depth in advance, the gap m (DOF: Depth of Focus) between the recording head 33 and the photosensitive element 31 of the process cartridge 30 can remain the same.

### Movement of Image Writing Unit During Operation of Opening Cover

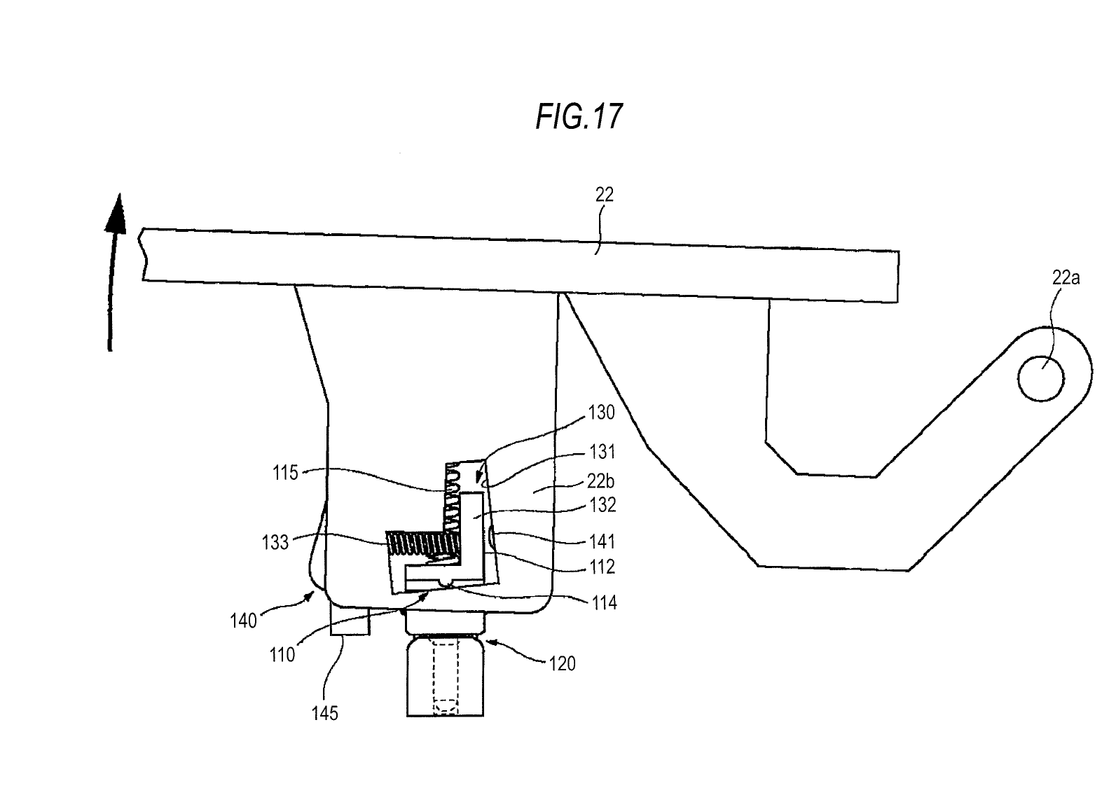

By referring to FIGS. 17 to 19, the movement of the image writing unit 100 during the operation of opening the cover 22 is described.

As shown in FIG. 17, when the open/cover 22 currently in the state of closed completely is started to open, such a movement of the cover 22 brings the lower edge portions of the support holes 111 to respectively come in contact with the support portions 112 of the recording head 33. Thereafter, the positioning protrusion 125 of the positioning mechanism 120 is gradually pulled out from the positioning hole 121.

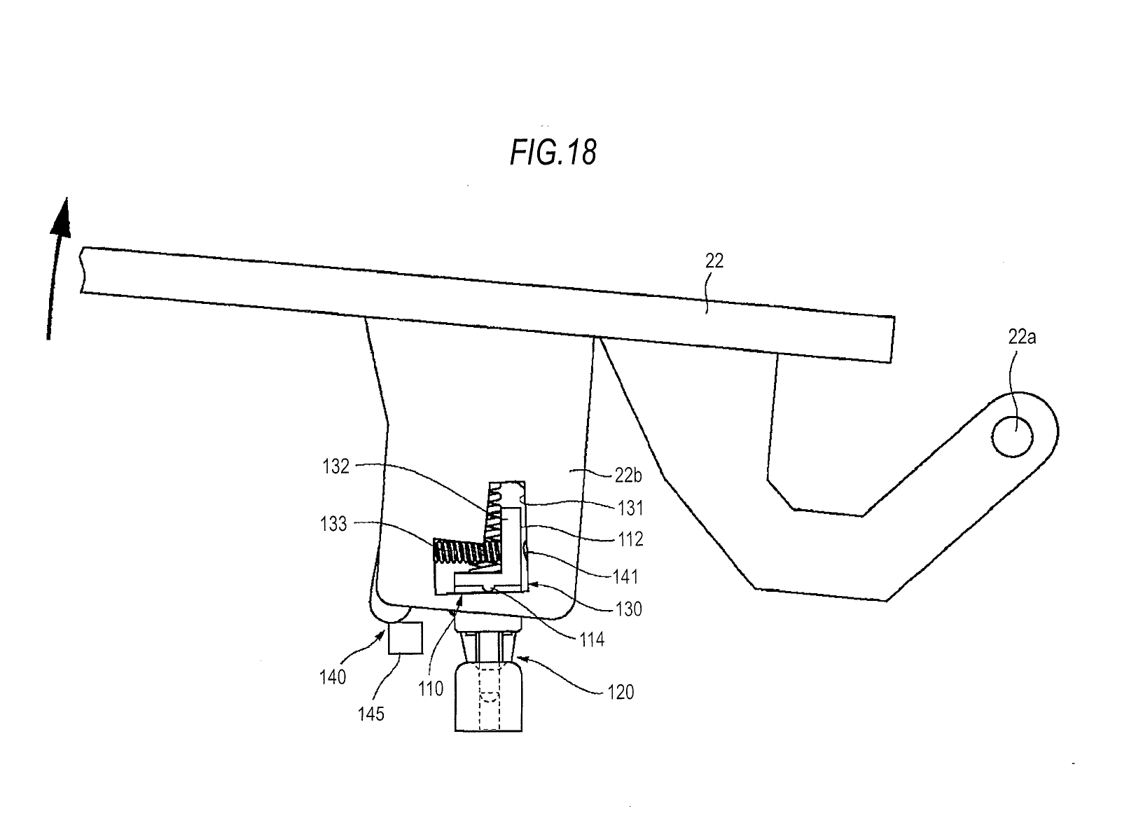

At this time, as shown in FIG. 18, the recording head 33 is being in contact with the lower edge portions of the support holes 111 of the side walls 22b of the cover 22 via the swing fulcrum protrusions 114 of the support portions 112. Accordingly, the force of pulling out the recording head 33 is acted mainly at a point of the swing fulcrum protrusion 114 of each of the support portions 112. In this state, in the exemplary embodiment, the swing fulcrum protrusion 114 of the support portion 112 is located at the position corresponding to the axis of the positioning protrusion 125 of the positioning mechanism 120, and thus the direction for the pull-out force of the recording head 33 becomes substantially the same as the direction for the positioning protrusion 125 of the positioning mechanism 120 to move away from the positioning hole 121. This thus favorably reduces the friction force to be generated between the positioning protrusion 125 and the circumferential walls of the positioning hole 121 due to the tilting of the positioning protrusion 125 of the positioning mechanism 120 so that the recording head 33 is pulled out more smoothly than with the configuration for a comparative example.

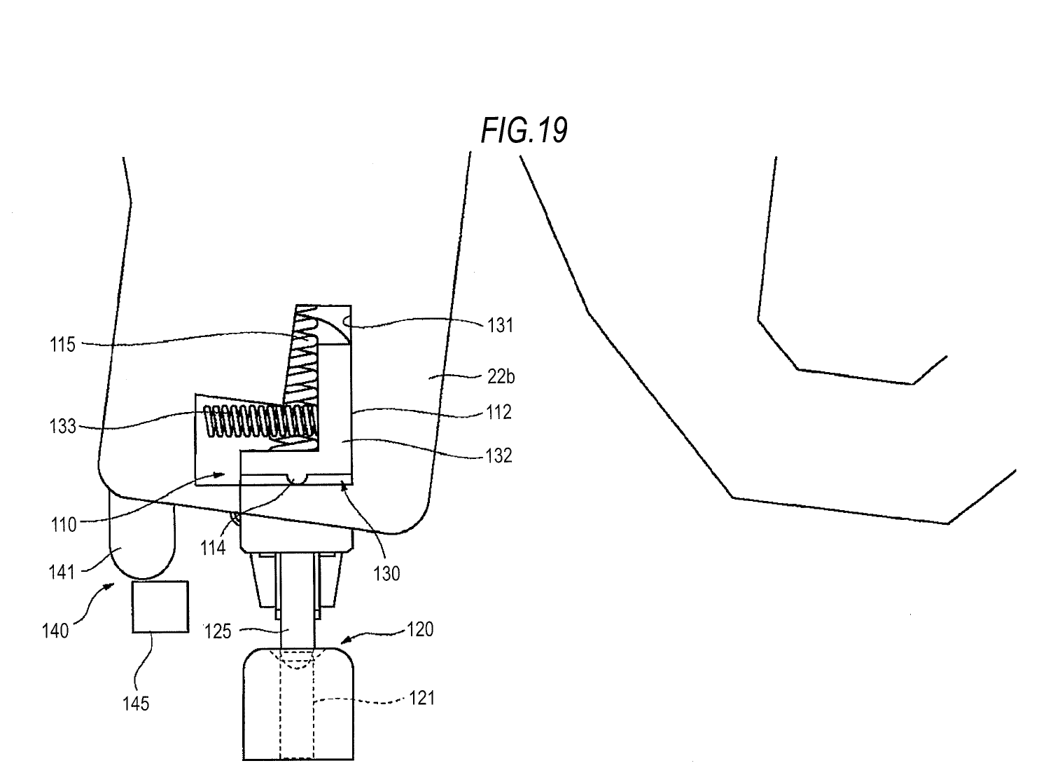

When the cover 22 is open to a further degree, as shown in FIG. 19, when the positioning protrusion 125 of the positioning mechanism 120 is pulled out from the positioning hole 121, the position holding mechanism 130 is operated, and the recording head 33 is held at a predetermined restraint position and is moved together with the cover 22 in the direction of opening.

### Modified Example

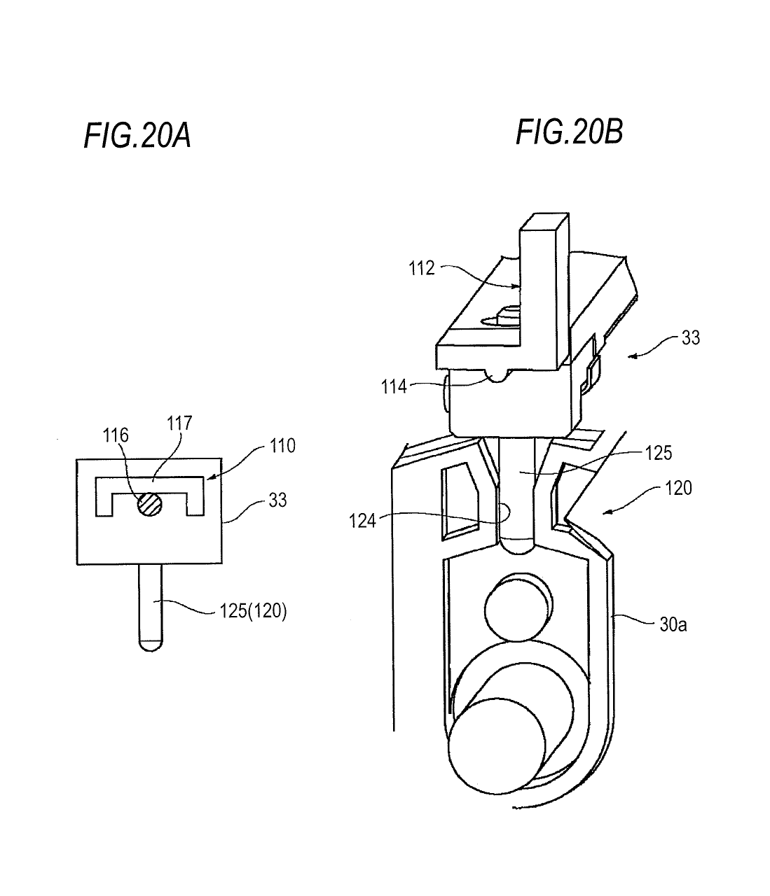

In the first exemplary embodiment described above, the support mechanism 110 is exemplified as including the support hole 111 and the support portion 112, i.e., the protrusion portion 113 having the cross section in the shape of substantially a letter L, and the swing fulcrum protrusion 114. This is surely not restrictive, and as exemplarily shown in FIG. 20A, a support protrusion 116 having the cross section in the shape of a circle is disposed to each of the side walls 22b of the cover 22 to protrude therefrom. On each of the end portions of the recording head 33, a supported protrusion 117 having the cross section in the shape of a square bracket is disposed to protrude therefrom, and such supported protrusions 117 are supported by the support protrusions 116 to be able to move relatively and swingably move in the direction along the cover surface of the cover 22.

Also in the exemplary embodiment described above, as exemplarily shown in FIG. 20B, the positioning mechanism 120 is exemplified as including the positioning hole 121 and the positioning protrusion 125. This is surely not restrictive, and the cartridge body 30a may be provided with a positioning groove 124 as an alternative to the positioning hole 121, and this positioning groove 124 may be inserted with the positioning protrusion 125 like a hook.

### Second Exemplary Embodiment

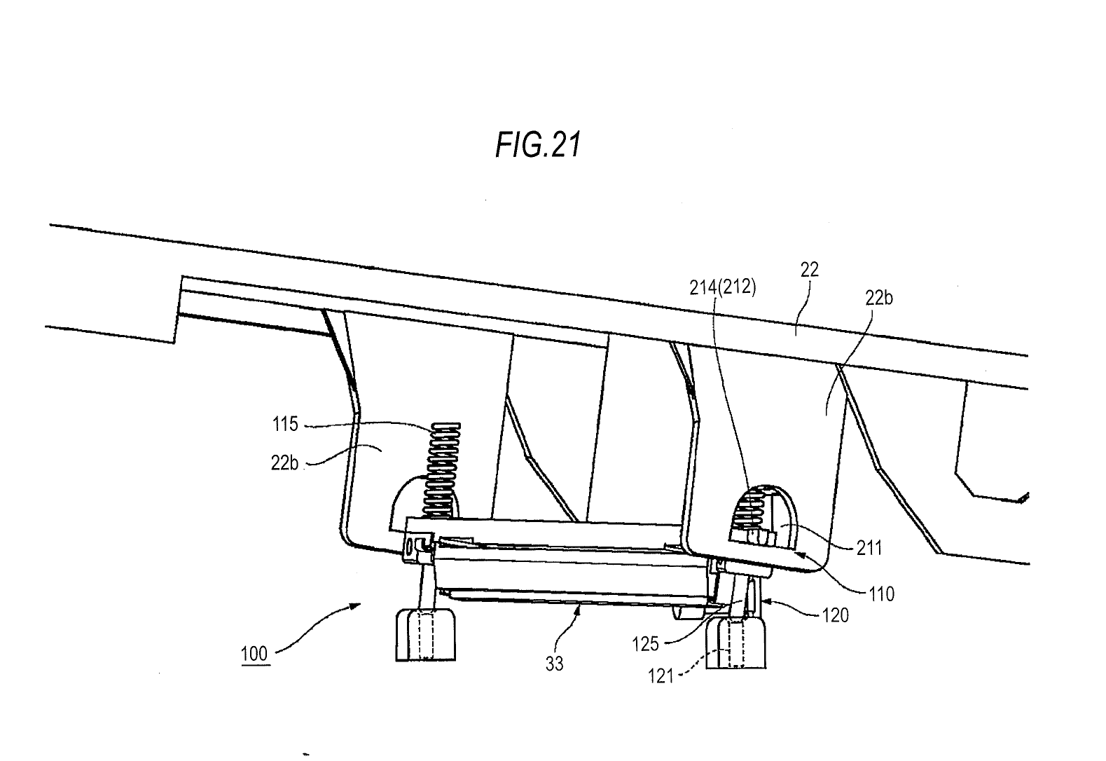

FIG. 21 is a diagram showing the main components in an image writing unit of a second exemplary embodiment.

In the drawing, the image writing unit 100 is configured to include the recording head 33 being an LED head, the support mechanism 110, the positioning mechanism 120, and the position holding mechanism 130. The support mechanism 110 serves to support the recording head 33 on the side of the cover 22. The positioning mechanism 120 serves to position the recording head 33 to the cartridge body 30a of the process cartridge 30, which is detachably incorporated to the side of a device body 21. The position holding mechanism 130 holds, before the positioning of the recording head 33 by the positioning mechanism 120, the recording head 33 at a predetermined restraint position to make it remain in a position ready for positioning by the positioning mechanism 120.

In such an image writing unit 100 of the second exemplary embodiment, the recording head 33 and the positioning mechanism 120 are both configured substantially the same as those in the first exemplary embodiment, but the support mechanism 110 and the position holding mechanism 130 are both configured differently from those in the first exemplary embodiment.

Herein, any component similar to that in the first exemplary embodiment is provided with the same reference numeral in the first embodiment, and is not described in detail again.

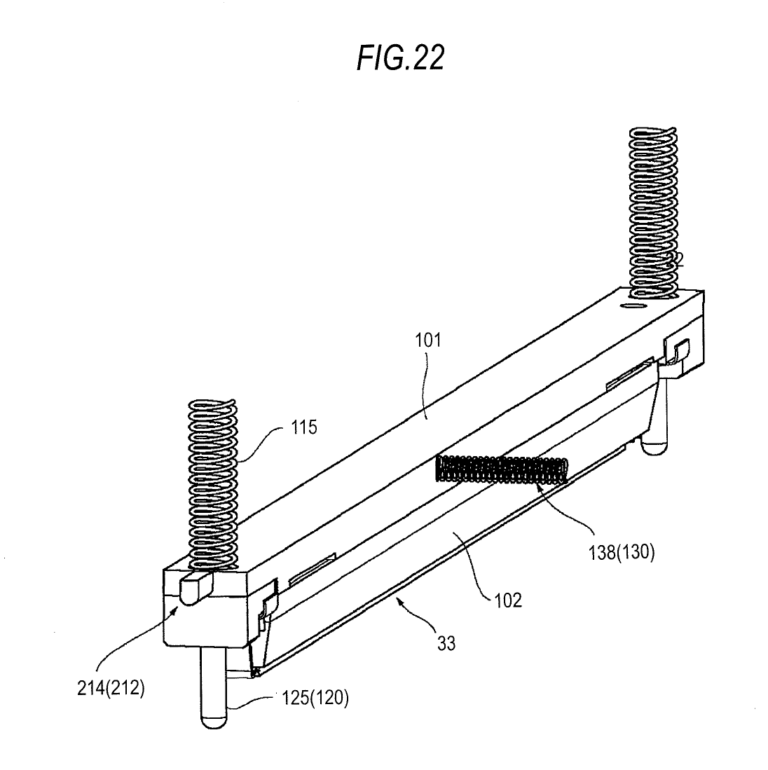

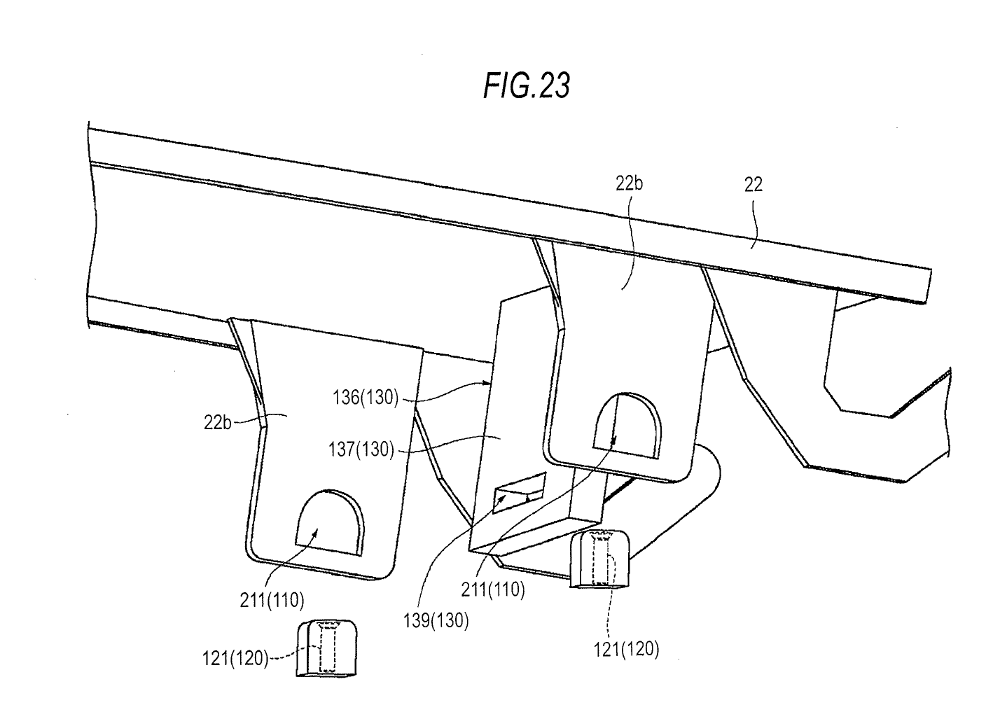

In this exemplary embodiment, as shown in FIGS. 21 to 23, the support mechanism 110 is provided with a support hole 221 to each of the side walls 22b of the cover 22. The support hole 211 is formed with a semicircular hole portion to an upper portion of a rectangular hole portion. The support mechanism 110 is also provided with, at both end portions of the recording head 33, a support portion 212. The support portion 212 is configured only by a swing fulcrum protrusion 214 whose lower side is shaped like an arc-shaped portion. In the support hole 211, the lower edge portion serving as a guide surface extending along the cover surface of the cover 22 is in contact with the support portion 212, and the support portion 212 is pushed to and supported by the lower edge portion of the support hole 211 by the pushing force of the spring 115.

In the position holding mechanism 130, a plate-like restriction member 136 is disposed at the intermediate portion of the side walls 22b inside of the cover 22 to protrude therefrom. The surface of this restriction member 136 on the side of the recording head 33 is used as a restriction wall 137, and using the tensile force of a tensile spring 138, the recording head 33 is pressed to the restriction wall 137 for holding thereat.

In this example, the restriction member 136 may be a reinforcing member (reinforcing rib) of the cover 22, or may be additionally provided. As to the tensile spring 138, one end thereof is hooked substantially at the center of the base member 101 of the recording head 33 in the longitudinal direction, and extends to the side of the swing shaft 22a (hinge) of the cover 22 through an insertion hole 139 formed to the restriction member 136. The other end of the tensile spring 138 is hooked to the swing shaft 22a, and applies the tensile force to the recording head 33 in the direction toward the side of the swing shaft 22a.

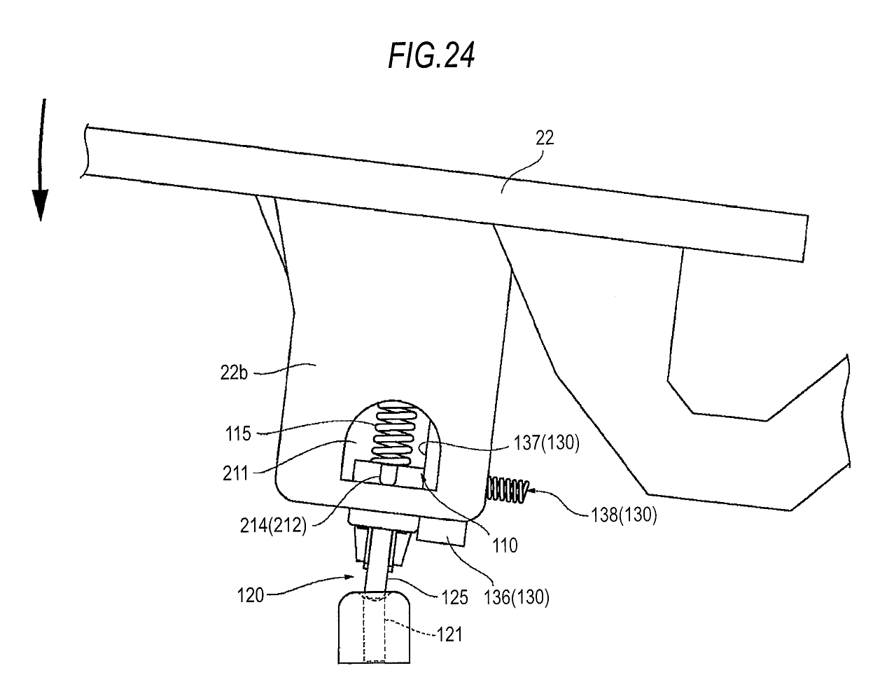

By referring to FIGS. 24 to 26, described next is the movement of the image writing unit 100 during the operation of closing the cover 22.

During the operation of closing the cover 22, before the positioning protrusion 125 of the positioning mechanism 120 is inserted into the positioning hole 121, the position holding mechanism 130 is operated. The recording head 33 is pressed to the restriction wall 137 of the restriction member 136 by the tensile strength of the tensile spring 138, and is kept at the restraint position defined by the restriction wall 137. Substantially similarly to the first exemplary embodiment, this restraint position is so set as to form a positional relationship that the positioning protrusion 125 of the positioning mechanism 120 can be inserted into the positioning hole 121.

As such, in the course of closing the cover 22, the positioning protrusion 125 of the positioning mechanism 120 is inserted smoothly into the positioning hole 121.

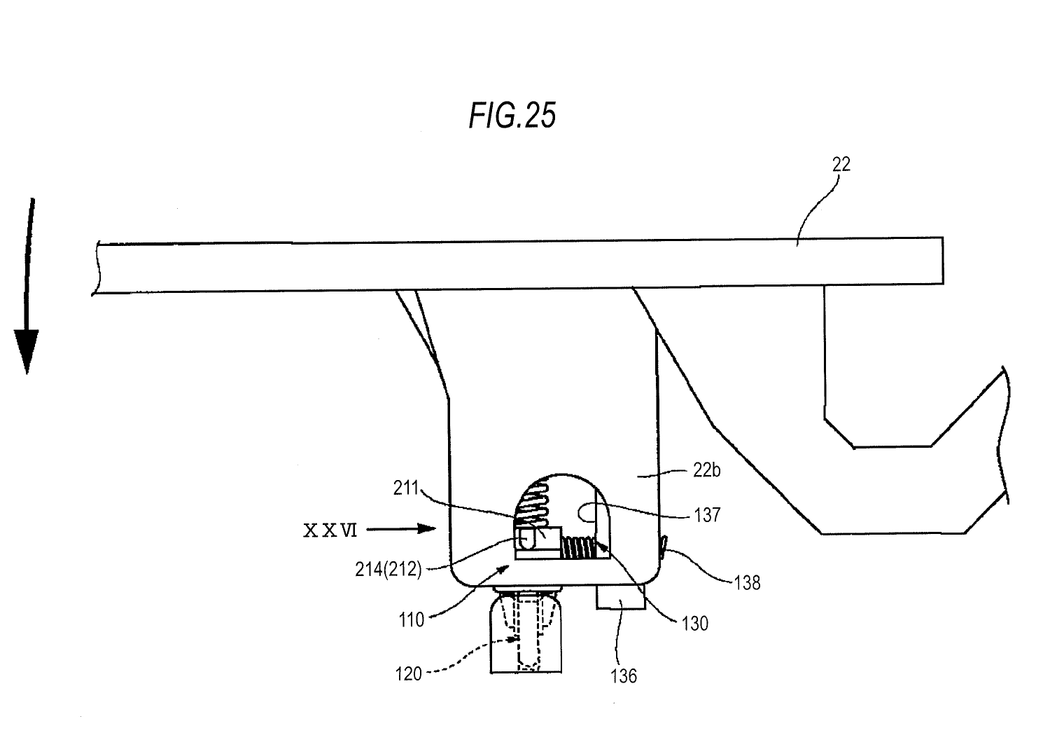

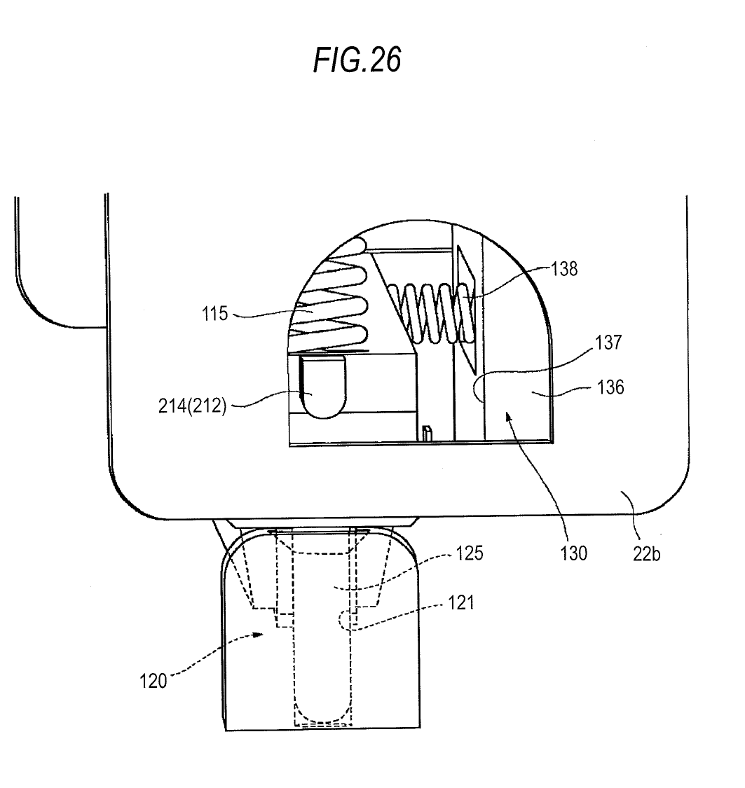

When the positioning protrusion 125 of the positioning mechanism 120 is inserted to reach the bottom portion of the positioning hole 121, as shown in FIGS. 25 and 26, the support portion 212 of the support mechanism 110 and the support hole 211 are not in contact any more, and the recording head 33 and the cover 22 are also not in contact any more. Therefore, the recording head 33 is positioned only by the positioning mechanism 120.

As such, substantially similarly to the first exemplary embodiment, the recording head 33 is positioned, with a good accuracy, with respect to the photosensitive element 31 (refer to FIG. 4) of the process cartridge 30.

The movement of the image writing unit 100 during the operation of opening the cover 22 is similarly to that in the first exemplary embodiment, and goes through the operation processes in reverse order to the movement of the image writing unit 100 during the operation of closing the cover 22.

Note that, in the second exemplary embodiment, the position change mechanism 140 in the first exemplary embodiment is not in use. Alternatively, any position change mechanism 140 having the similar functions may be surely provided for use.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the skilled in the art to understand the invention for various embodiments and with the various modifications as are suited to the particular use contemplated. It is intended that the scope of the invention be defined by the following claims and their equivalents.

What is claimed is:

1. An image writing unit, comprising:
an image writing member that writes images to an image holding member disposed on the side of a recording device body;
a support mechanism including a supporting section that allows the image writing member to be supported on the side of a cover that is open and closed with respect to the recording device body, and a supported section provided to the image writing member to be supported by the supporting section, the support mechanism supporting the image writing member on the side of the cover when the cover is left open; and
a positioning mechanism including a positioning section provided on the side of the recording device body for positioning the image writing member, and a positioned section provided on the side of the image writing member to be positioned by the positioning section, the positioning mechanism positioning the image writing member with respect to the image holding member on the side of the recording device body depending on the positional relationship between the positioning section and the positioned section when the cover is closed,
wherein one of the supporting section and the supported section in the support mechanism is provided with a guide surface extending along the direction perpendicular to the open/close direction of the cover, and the other section allows the image writing member to swingably move in response to the positioning of the image writing member by the positioning mechanism.

2. The image writing unit according to claim 1, wherein the image writing member swingably moves along the guide surface by a protrusion disposed on one of the positioning section and the positioned section in the support mechanism in response to the positioning of the image writing member by the positioning mechanism.

3. The image writing unit according to claim 2, wherein the image writing member relatively moves along the guide surface in response to the positioning of the image writing member by the positioning mechanism.

4. The image writing unit according to claim 2, wherein the protrusion configuring the support mechanism has outer dimensions along the guide surface equal to or smaller than dimensions of a positioning width of the positioning section or the positioned section in the positioning mechanism, and the protrusion comes in contact with at least a part of the guide surface of the dimensions within the positioning width.

5. The image writing unit according to claim 1, further comprising:
a position holding mechanism that holds, when the positioned section of the image writing member is out of contact with the positioning section of the recording device body, during an operation of closing the cover, the image writing member at a restraint position to be restrained by the cover to form the positional relationship in which the positioned section is ready for positioning by the positioning section, and releases the image writing member from being in a position at the restraint position with respect to the cover while the positioned section is contacting with the positioning section to be in a position ready for positioning.

6. The image writing unit according to claim 1, wherein the support mechanism is provided with a pushing member that pushes the supported section on the side of the image writing member toward the supporting section on the side of the cover.

7. The image writing unit according to claim 1, wherein, in the support mechanism, the supporting section is a support hole formed to each side wall of the cover, and has a hole edge portion formed with the guide surface, and the supported section is a support portion protruding from each side portion of the image writing member toward the support hole, and contacting with the support hole along the guide surface via the protrusion.

8. The image writing unit according to claim 7, wherein the support portion has a protrusion portion that protrudes from each of the side portions of the image writing member toward the support hole, and a protrusion is formed to a part of each of the protrusion portions to come in contact with the support hole along the guide surface to be able to freely move relatively thereto, and
wherein with the protrusions each serving as a fulcrum, the image writing member is allowed to swingably move with respect to the cover.

9. The image writing unit according to claim 1, wherein the positioning mechanism is provided with a positioning hole that serves as the positioning section formed on the side of the recording device body, and a positioning protrusion that serves as the positioned section formed on the side of the image writing member for insertion into the positioning hole, and
wherein for positioning of the image writing member during the operation of closing the cover, the positioning protrusion is disposed to make a tip end portion thereof come in contact with the bottom portion of the positioning hole, and a distance between the image holding member and the image writing member is set to a predetermined value.

10. The image writing unit according to claim 1, wherein the position holding mechanism is provided with a restriction wall by which the image writing member is restricted to take a predetermined restraint position, and a pressing member for pressing the image writing member to the restriction wall.

11. The image writing unit according to claim 10, wherein in the support mechanism, the supporting section is the support hole formed to each of the side walls of the cover, and has the hole edge portion formed with the guide surface, and the supported section is the support portion protruding from each of the side portions of the image writing member toward the support hole, and contacting with the support hole along the guide surface via the protrusion, and
wherein in the position holding mechanism, the restriction wall is an edge portion of each of the support holes serving as the supporting section in the support mechanism, and a restricted portion is formed to a part of each of the support portions serving as the supported section in the support mechanism to abut the restriction walls.

12. The image writing unit according to claim 10, wherein in the position holding mechanism, a restriction member is disposed inside of the cover to protrude therefrom, and a wall of the restriction member on the side of the image writing member is used as a restriction wall for restricting, in position, an intermediate portion of the image writing member.

13. The image writing unit according to claim 1, further comprising: a position change mechanism for, while the positioned section is contacting with the positioning section to be in a position ready for positioning, contacting with the members on the side of the image writing member, and changing a position of the image writing member in a direction of being released from the restraint position,
wherein when the positioned section is in the position ready for positioning, the image writing member and the position change mechanism are out of contact with each other.

14. The image writing unit according to claim 13, wherein the position change mechanism includes a cam member rotatably disposed on the side of the cover, and the cam member having an eccentric cam section around a rotation shaft and a movable arm section at a part of the eccentric cam section, and an abutting member disposed on the side of the recording device body, and rotating the eccentric cam section of the cam member by being abutted by the movable arm section of the cam member in response to the operation of closing the cover, and
wherein when the positioned section starts to come in contact with the positioning section, the position change mechanism changes the position of the image writing member in a direction of being released from the restraint position by the eccentric cam section of the cam member.

15. An image recording device, comprising:
a recording device body provided with an image holding member;
an cover that swingably moves with respect to the recording device body to open and close; and
the image writing unit of claim 1, disposed on a side of the cover for writing of an image to the image holding member.

16. An image recording device, comprising:
a recording device body provided with an image holding member;
an cover that swingably moves with respect to the recording device body to open and close; and
the image writing unit of claim 2, disposed on a side of the cover for writing of an image to the image holding member.

17. An image recording device, comprising:
a recording device body provided with an image holding member;
an cover that swingably moves with respect to the recording device body to open and close; and
the image writing unit of claim 3, disposed on a side of the cover for writing of an image to the image holding member.
